(19) United States
(12) Patent Application Publication
(10) Pub. No.: US 2009/0267728 A1
(43) Pub. Date: Oct. 29, 2009

(54) METHOD OF VISITING A SITE

(76) Inventor: YVES MAYRAND, Beaconsfield (CA)

Correspondence Address: GOUDREAU GAGE DUBUC, 2000 MCGILL COLLEGE, SUITE 2200, MONTREAL, QC, H3A 3H3, CA

(21) Appl. No.: 12/427,356

(22) Filed: Apr. 21, 2009

Related U.S. Application Data
(60) Provisional application No. 61/047,210, filed on Apr. 23, 2008.

(51) Int. Cl. H04L 9/32; G06F 17/30

(52) U.S. Cl. 340/5.6; 707/104.1; 707/1; 340/5.74; 707/E17.044; 707/E17.001

(57) ABSTRACT

A method and system for providing an interactive experience to a visitor of an entertainment venue comprising a plurality of locations. The visitor is assigned a portable identification device having stored thereon information uniquely identifying the visitor. A central computer then randomly directs the visitor to a first one of the locations and retrieves at the first location the information from the identification device in order to identify the visitor. In this manner, the visitor can be presented with content customized according to his/her unique profile.

### CROSS REFERENCE TO RELATED APPLICATIONS

This application claims priority on U.S. Provisional Application No. 61/047,210, filed on Apr. 23, 2008 and which is herein incorporated by reference in its entirety.

### FIELD OF THE INVENTION

The present invention relates to a method of visiting a site. In particular, an interactive visit system that can be modified and/or updated to generate repeat visits and unique experiences for visitors of an entertainment venue or cultural event is created.

### BACKGROUND OF THE INVENTION

In order to generate repeat business from customers, entertainment venues, and/or cultural events are faced with the recurring problem of renewal, update and refinement of their product offerings. Indeed, given the fast-evolving nature of the entertainment field, repeat visits from customers are not likely to be achieved unless venues offer experiences that generate renewed or sustainable interest from the visitors. Thus, in order to compete with the changing demand for the latest and newest attraction, it is desirable for venues to regularly renew their offering in an easy and timely manner.

Typically, entertainment facilities usually offer a single and linear (e.g. museum visit following a historical timeline) course of visit to customers. Also, a limited amount of site- or theme-specific information about the items on display is provided through signage, printed hand-outs, computerized information kiosks, guided tours, and the like. As reinventing a brand new experience (in terms of content) is not easily achieved, the production of a new scenario is a critical decision for any type of entertainment facility especially since such a decision requires a major financial investment in order to achieve an inventive and original, thus competitive, result. Consequently, the content is seldom completely updated without changing the overall experience (i.e. the physical installations) and most entertainment or cultural venues thus have a limited outreach. Indeed, when faced with the need to renew the offering, venues typically change the entire experience, thus proving time, money and resource consuming. Alternatively, portions of the experience are updated, thus only providing partial renewal of the offering and having, in terms of customer outreach, the same effect as holding a temporary event on the premises.

What is therefore needed, and an object of the present invention, is an electronic system that answers the logistical problem of content renewal faced by entertainment venues and enriches the visitors' experience by facilitating the update and renewal of an offering without requiring for a change in the physical installations.

### SUMMARY OF THE INVENTION

More specifically, in accordance with the present invention, there is provided a method for providing an interactive experience to a visitor of an entertainment venue comprising a plurality of locations. The method comprises the acts of a. providing information uniquely identifying the visitor, b. assigning the visitor a portable identification device having stored thereon the information, c. randomly directing the visitor to a first one of the plurality of locations, d. retrieving at the first one of the plurality of locations the information from the identification device, thereby identifying the visitor, e. presenting the visitor with content customized according to the retrieved information, and repeating acts c, d, and e for remaining ones of the plurality of locations.

Still in accordance with the present invention, there is also provided a system for providing an interactive experience to a visitor of an entertainment venue comprising a plurality of locations. The system comprises a portable identification device assigned to the visitor and having stored thereon information uniquely identifying the visitor and a computer system in communication with the identification device and the plurality of locations. The computer system a. randomly directs the visitor to a first one of the plurality of locations, b. retrieves at the first one of the plurality of locations the information from the identification device, thereby identifying the visitor, c. presents the visitor with content customized according to the retrieved information, and repeats acts a, b, and c for remaining ones of the plurality of locations.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

FIG. 1 is a schematic diagram of an interactive visit system in accordance with an illustrative embodiment of the present invention;

FIG. 2 is a flowchart of a method for visiting an entertainment venue in accordance with an illustrative embodiment of the present invention;

FIG. 3A is a schematic diagram of visitors arriving at a first location in accordance with an illustrative embodiment of the present invention;

FIG. 3B is a schematic diagram of a visitor entering a first location and being identified at the first location in accordance with an illustrative embodiment of the present invention;

FIG. 4 is a schematic diagram of visitors being delivered content in a first location in accordance with an illustrative embodiment of the present invention;

FIG. 5A is a schematic diagram of a visitor being identified at an individual monitor in accordance with an illustrative embodiment of the present invention;

FIG. 5B is a schematic diagram of a visitor undergoing a customized challenge at an individual monitor in accordance with an illustrative embodiment of the present invention;

FIG. 6 is a schematic diagram of visitors being directed towards a second location in accordance with an illustrative embodiment of the present invention;

FIG. 7A is a schematic diagram of a first itinerary in accordance with an illustrative embodiment of the present invention;

FIG. 7B is a schematic diagram of a second itinerary in accordance with an illustrative embodiment of the present invention; and

FIG. 8 is a schematic diagram of an interactive visit system in accordance with an alternative illustrative embodiment of the present invention.

### DETAILED DESCRIPTION OF THE ILLUSTRATIVE EMBODIMENTS

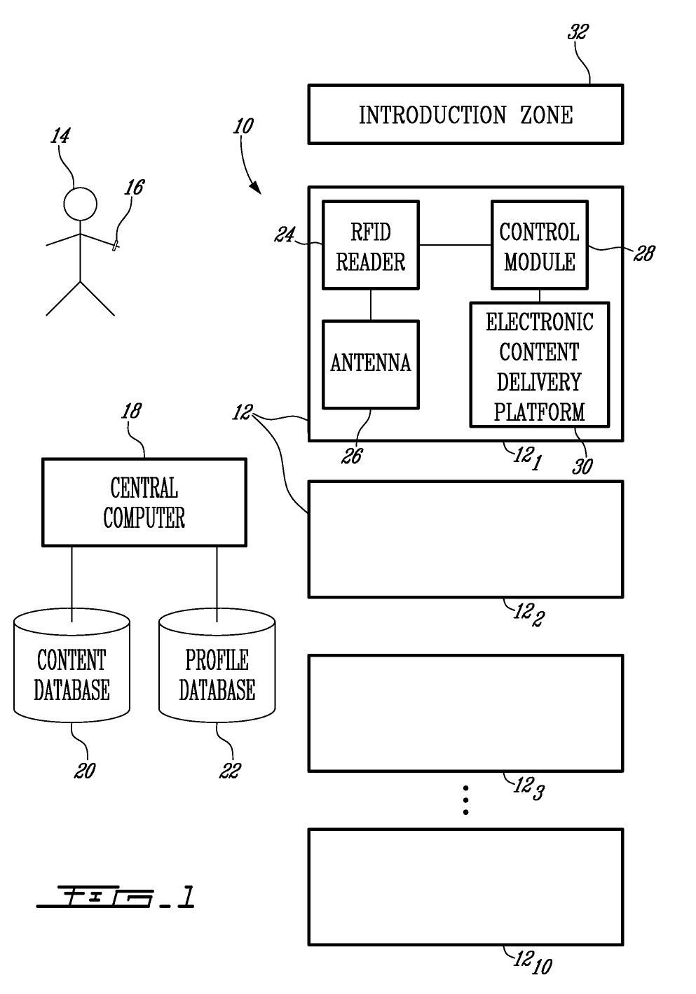

Referring now to FIG. 1, an illustrative embodiment of a renewable interactive visit system, generally referred to using the reference numeral 10, will now be described. The system 10 is implemented in an entertainment venue (e.g. museum, amusement park, art gallery . . . ) having a series of rooms or locations as in 12, illustratively 10 interior or exterior locations 12₁, 12₂, 12₃, . . . , and 12₁₀, through which visitors as in 14 circulate. The visitors as in 14 are illustratively equipped with a portable identification and tracking device 16, such as a Radio Frequency Identification Device (RFID) bracelet, which enables tracking of their whereabouts and control of access to the entertainment venue. The system 10 further comprises a central computer 18 connected to a content database 20. A profile database 22 may further be provided for storing data related to the visitors as in 14 for statistical purpose. Each location as in 12 also comprises a reader 24, illustratively an RFID reader, linked to an antenna 26 for receiving and interpreting information from the identification device 16. The locations as in 12 also comprise a control module 28 and an electronic content delivery platform 30 for presenting data to the visitors as in 14, as will be detailed further herein below. The control module 28 is illustratively in communication (e.g. wireless) with the electronic content delivery platform 30 and to the central computer 18.

Still referring to FIG. 1, the locations as in 12 are independent and each relate to the various sites and/or exhibits on display at the entertainment venue. As a result, the locations as in 12 offer different content (illustratively digital content) and are arranged in different layouts, with each location 12 comprising a plurality of zones (e.g. rest area, animations and demonstration, contemplation, regrouping). Preferably, each location 12 has an associated set of information stored in the content database 20, which illustratively includes information developed or gathered by the entertainment venue. For example, in the case of a museum, such information may include identification of a particular item on display and interesting trivia relating to the item. As will be apparent to a person skilled in the art, the information stored in the content database 20 is preferably indexed in a plurality of ways. For example, the information related to a particular exhibit may be classified using a plurality of indexes (e.g. identification numbers), with each index being uniquely assigned to one of the locations as in 12. Illustratively, this indexing of the information and of the locations as in 12 further enables the central computer 18 to randomly assign an itinerary to the visitors as in 14, as will be described in further detail herein below.

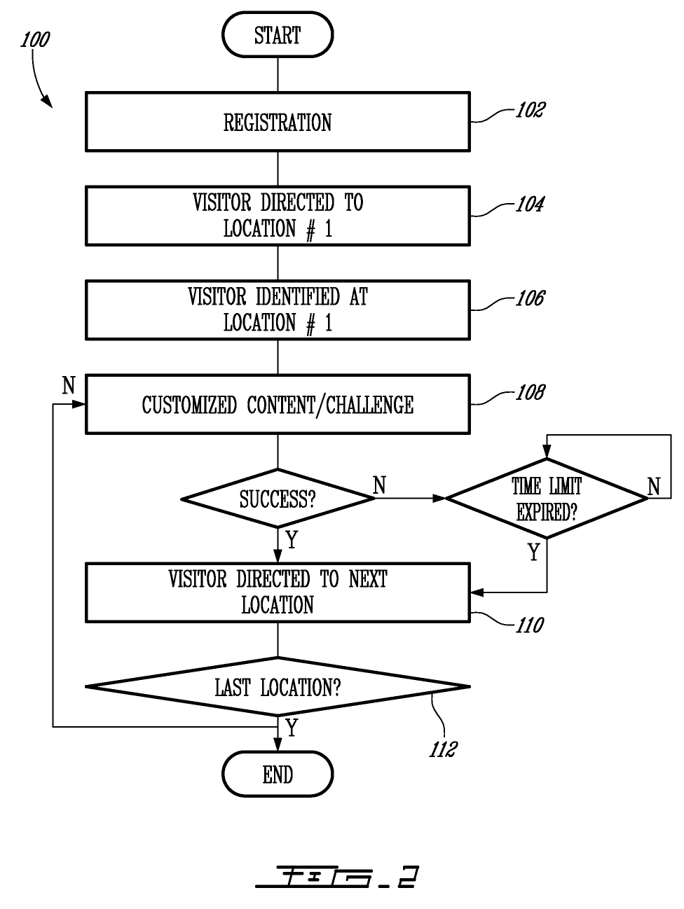

Referring now to FIG. 2 in addition to FIG. 1, a method 100 for visiting an entertainment venue comprising a plurality of locations as in 12 will now be described. Illustratively, each visitor or group of visitors as in 14 arriving at the entertainment venue is invited to register (step 102) in an introduction zone 32. During this registration phase, the visitors as in 14 typically provide identification information (e.g. name, demographic information, contact information) as well as their preferences having regard to the visit at hand (e.g. language, level of difficulty for subsequent challenges, if any, as will be discussed further herein below . . . ). This information, which may be provided by answering basic questions on a questionnaire returned to an attendant (not shown) or inputted directly into a computerized machine (not shown), constitutes the unique profile of each visitor 14. Illustratively, the questionnaire will be adapted to different age groups in order to better tailor the experience to the variety of visitors as in 14. Each visitor as in 14 is then assigned (by the attendant or the machine) a unique RFID bracelet 16 having stored (or addressably identified) thereon information related to his/her unique profile, as submitted during registration. Alternatively, all members of a group of visitors as in 14 may be assigned the same identification so that they all receive the same RFID bracelet 16, which is thus reused. The RFID bracelet 16 will illustratively be used throughout the visit in order to identify each visitor 14 as he/she enters a location 12, as well as track and control his/her physical location in real-time. Moreover, the RFID bracelet 16 will enable the central computer 18 to tailor the experience and content of the visit to each visitor 14 based on the preferences stored in his/her profile.

Still referring to FIG. 1 and FIG. 2, the RFID bracelet 16 illustratively comprises integrated circuitry (not shown) for storing and processing information and modulating/demodulating emitted signals, and an antenna (not shown) for receiving and transmitting signals towards a suitable reader, such as the RFID reader 24. The RFID bracelet 16 is illustratively operable to provide relative short-range RF communications (less than 60 cm) with the RFID reader 24. It will be apparent to a person skilled in the art that any other identifying device, such as a smart card or a magnetic “swipe” stripe card, suitable for storing information identifying each visitor 14 could be used without departing from the scope of the present invention.

Still referring to FIG. 1 and FIG. 2, after receiving the RFID bracelet 16, the visitor 14 is provided with information regarding the rules and/or conventions of the visit. The experience may illustratively comprise a series of challenges to be completed by the visitors as in 14 in each location 12 in order for them to have access to the next location 12. The introduction information may thus include the time allowed to complete a task or challenge and the manner in which the visitor 14 will be directed from one location 12 to the next upon completion of the task or challenge. Alternatively, depending on the type of venue or audience, it may be desirable to implement a less interactive experience and, as such, no challenges will need to be completed at each location 12 by the visitors as in 14 who will instead be presented with customized content related to the visit. At step 104, the visitor 14 is then directed to the first location 12₁ on his/her itinerary, as randomly determined by the central computer 18 based on the location's index. Indeed and as opposed to free-flow, the central computer 18 illustratively assigns an itinerary by pulsing the departure to the visit (e.g. by randomly retrieving a first location index and directing the visitor 14 to the corresponding location) and subsequently controlling access and circulation (i.e. entrance and exits) of the visitors as in 14 among the different locations as in 12. This subsequent control is based on information retrieved from the RFID bracelet 16 along the visitors' itinerary, as will be detailed further herein below. As will be apparent to a person skilled in the art, the number (illustratively 10) of locations as in 12 is selected so as to provide a high number of possible visits (illustratively up to 243 permutations) among the different locations as in 12, thus enhancing the experience of the visitor 14.

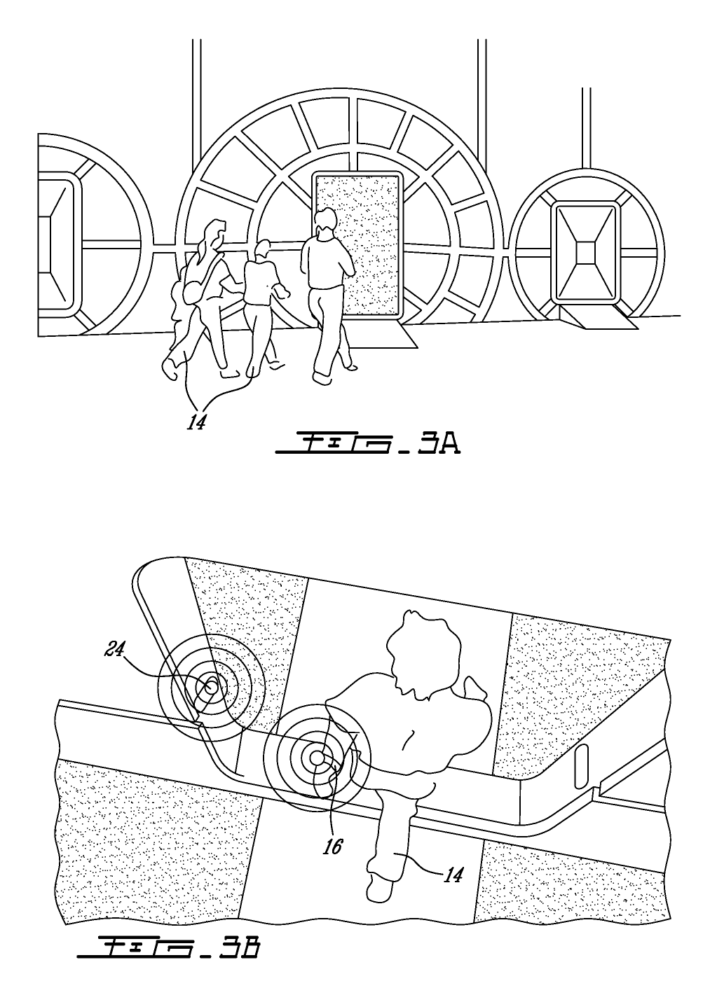

Referring now to FIG. 3A and FIG. 3B in addition to FIG. 1 and FIG. 2, once the visitor 14 arrives at the first location 12₁ on his/her itinerary, the RFID bracelet 16 emits a signal (containing the visitor's identification information or a serial number of the RFID bracelet 16 for example), which is received by the antenna 26 and interpreted by the RFID reader 24 embedded at the first location 12₁ (illustratively in the door) (FIG. 3B). Upon interpreting the received signal, the RFID reader 24 is able to identify the visitor 14 (step 106) and thus allows him/her access to the room by instructing the control module 28 to open the door. As will be apparent to a person skilled in the art, if the RFID reader 24 fails to identify the visitor 14, the door will not open and the visitor 14 cannot enter the location 121.

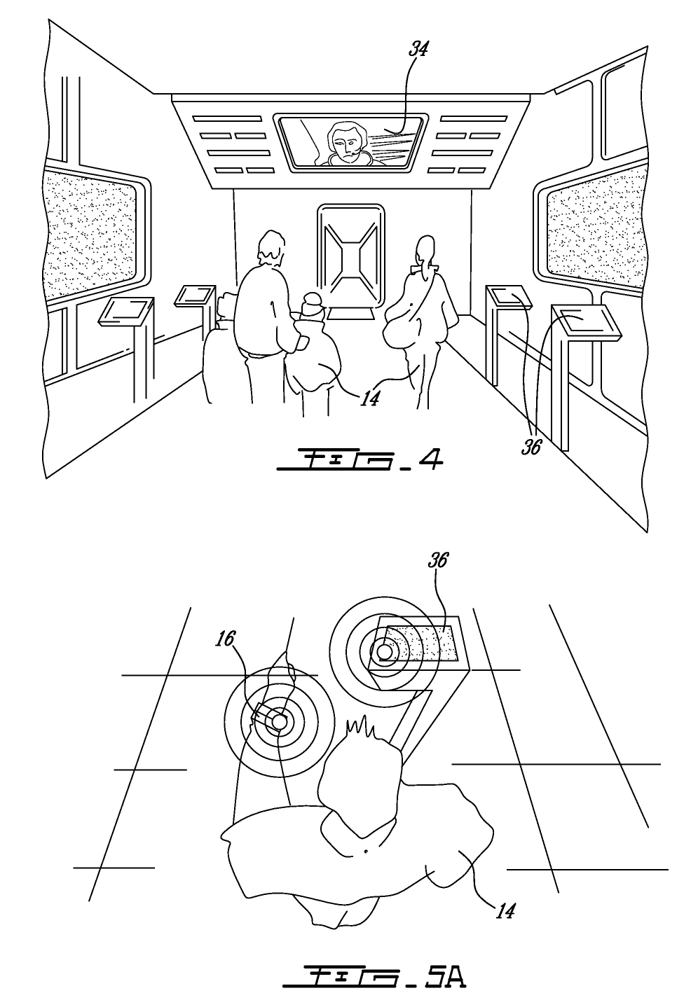

Referring now to FIG. 4 in addition to FIG. 1 and FIG. 2, the electronic content delivery platform 30 of each location 12 is used to deliver content to the visitors as in 14 via a plurality of electronic devices such as video screens and video projectors. For example, each location 12 may comprise a main screen 34 and a plurality of individual monitors 36 for presenting customized content to each visitor or group of visitors 14. Illustratively, the visitors as in 14 are initially welcomed on the main screen 34 (e.g. by a character or the like) and general information related to the exhibit at location 12₁ is delivered. For this purpose, the control module 28 contacts the central computer 18, which retrieves from the content database 20 general content associated with the exhibit of location 12₁. This didactic content is then sent to the control module 28, which further transmits it to the main screen 34 of the electronic content delivery platform 30 for rendering thereon. As will be apparent to a person skilled in the art, this content may be adapted to the specific field of the venue. Also, it will be apparent that the content may alternatively be delivered to mobile communication devices (not shown), such as cellphones, Personal Digital Assistants (PDAs), or the like carried by the visitors as in 14.

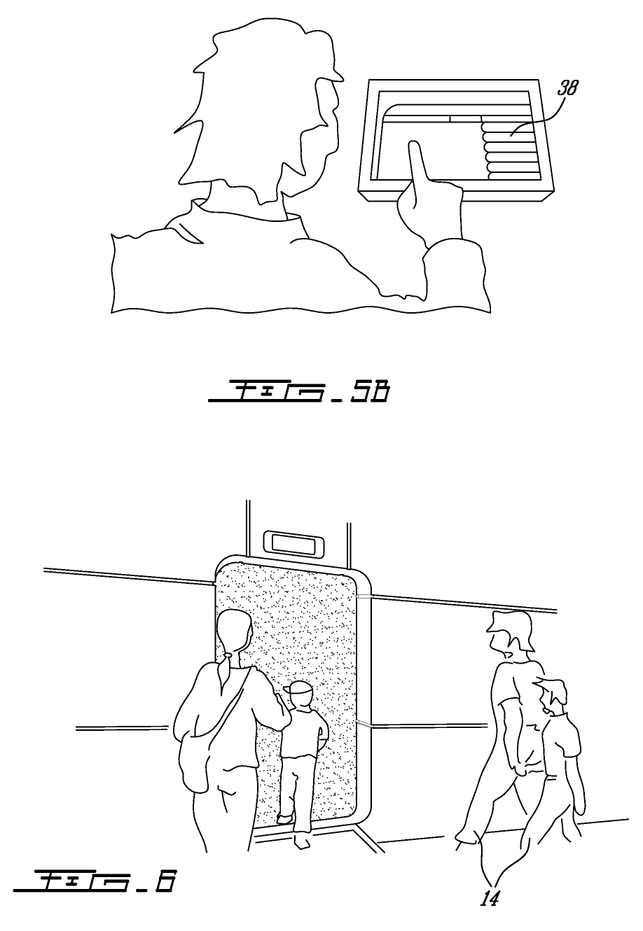

Referring now to FIG. 5A and FIG. 5B in addition to FIG. 1 and FIG. 2, each visitor 14 is subsequently directed to one of the individual monitors 36 in order to be delivered customized content. For example, if the experience comprises a challenge portion, the visitor's comprehension of the previously delivered content may be tested. Illustratively, the visitor 14 is identified at the individual monitor 36 through the RFID bracelet 16. For this purpose, it is desirable for the individual monitor 36 to comprise an RFID reader and antenna (both not shown) operating in a manner similar to the RFID reader 24 embedded in the door of location 12₁. Upon being identified at the individual monitor 36, profile information of the visitor 14 is sent to the control module 28, which contacts the central computer 18 using this information as an input. Upon receiving the profile information, the central computer 18 fetches from the content database 20 content (e.g. information related to a particular exhibit, tasks and/or questions if the experience includes a challenge component), which matches the visitor's profile. For example, if, according to the profile, the visitor 14 wishes to undergo an experience in the English language and having a low-level of difficulty, the central computer 18 retrieves low-level content in English from the content database 20 and transmits this content to the control module 28, which further sends the personalized content (e.g. question/answer game if applicable) to the individual monitor 36 for rendering thereon (step 108) to each visitor 14. In the case of groups of visitors as in 14, the same personalized content is illustratively presented to all members of the group, which are assigned the same identification, as discussed herein above. It is now apparent that a variety of content (e.g. challenges) is available and customizable to individuals or groups of visitors as in 14, based on their unique abilities and/or interests in the given field of the venue, as specified during the registration phase.

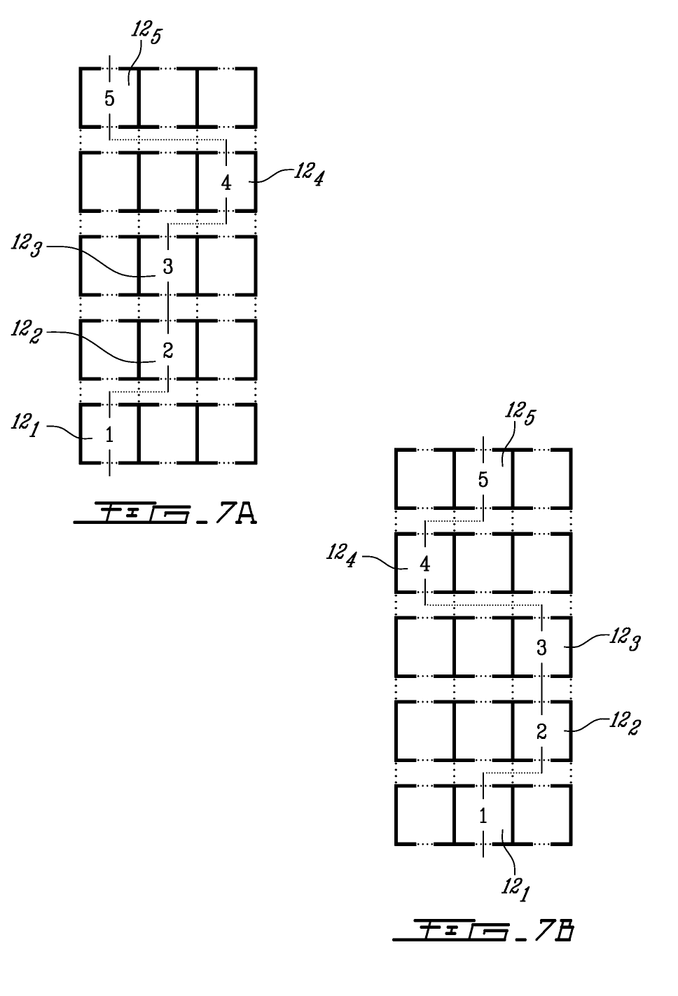

Referring now to FIG. 6 in addition to FIG. 1, FIG. 2, and FIG. 5B, the visitor 14 is illustratively directed to the next location (e.g. 12₂) randomly selected by the central computer 18 after being presented the personalized content and upon expiry of a pre-determined time limit. For example, if the experience comprises a challenge component, after being presented with a task and/or question, the visitor 14 is illustratively provided a time limit to submit an answer via a user interface 38 (e.g. a keyboard or the like) provided on the individual monitor 36. The answers are then transmitted via the control module 28 to the central computer 18, which analyzes them and assesses their accuracy. The visitor 14 is only directed to the next location on the visitor's itinerary once the challenge is completed (i.e. the visitor 14 answers all tasks/questions properly or time runs out without any answer or any proper answer having been submitted). For this purpose, the central computer 18 randomly selects the next location (e.g. 12₂) on the visitor's itinerary and illustratively instructs the control module to open the door to the current location 12₁. The visitor is then invited to leave the location 12₁ and to proceed towards the next location (e.g. 12₂) on the itinerary (step 110). The method 100 repeats for all locations as in 12 until the visitor 14 has completed his/her itinerary (step 112), as randomly determined by the central computer 18. As will be apparent to a person skilled in the art, the process could be either interactive as described herein (e.g. the visitors as in 14 are guided to a particular location 12) or not. Also, if the visitor 14 has expressed such a desire when submitting his/her profile during the registration phase, the itinerary may only comprise a selected number of locations as in 12, based on the visitor's interest profile, thus allowing for the length of the experience to be varied.

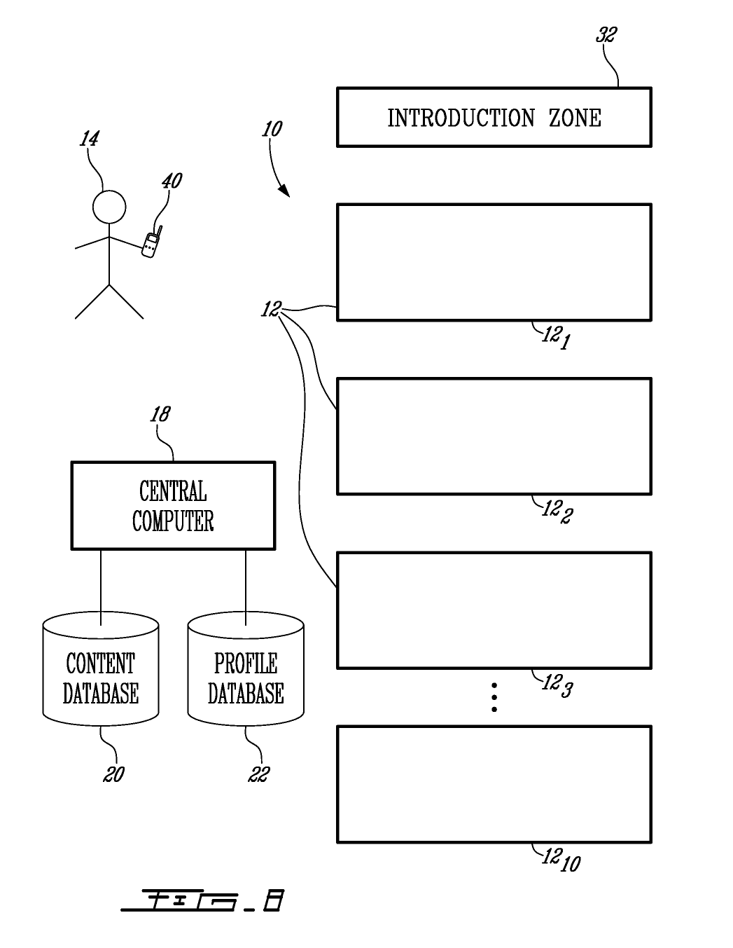

Referring now to FIG. 1, FIG. 7A and FIG. 7B, the central computer 18 may, as an added feature, store in the profile database 22 identification and profile information related to the visitors as in 14. This will provide statistics about each visitor 14 (e.g. in the form of a use sequence number showing the number of times a specific RFID bracelet 16 has been used) in order to better tailor each visitor's experience upon a subsequent visit. As such, the central computer 18 ensures that a new experience is offered to a given visitor 14 on a repeat visit at the entertainment venue. In addition to randomly selecting the itinerary of a visitor 14 upon each visit at the venue, this may for instance be achieved (when the experience comprises a challenge component) by providing the visitor 14 on a next visit with a challenge having a higher level of difficulty as the challenge completed during a previous visit. Alternatively, if information stored in the profile database 22 shows that the visitor 14 had difficulty completing a challenge presented during the previous visit, the difficulty level may be lowered on the subsequent visit. As will be apparent to a person skilled in the art, the present invention thus offers the advantage of providing a flexible content to customers upon repeat visits, such content being modifiable on demand. As a result, and as illustrated in FIG. 7A and FIG. 7B, which show two different itineraries that may be provided on a repeat visit, the visitors as in 14 are provided upon each subsequent visit at the venue with a renewed experience, which may be as interactive and immersive as desired.

Referring back to FIG. 1 and according to an alternative illustrative embodiment of the present invention, a web game version of the installation provided at the entertainment venue may be implemented so as to provide training sessions for the visitors as in 14 prior to the on-site experience. In this embodiment, a website corresponding to the experience (e.g. sneak preview, virtual tour of the locations as in 12) may be created to enable a visitor 14 to view the content prior to a visit. As a result, the visitor 14 is likely to derive a more rewarding experience from the visit. The web game version may, for example, be made available in schools, in which case the content delivered to the visitors as in 14 would illustratively be tailored to match school curriculum. In-class preparation could therefore be provided as the material prepared in class could be used to enhance the visit (or assist in potential challenges). Alternatively, content could be gathered from the website and made portable on a mobile device, such as a mobile phone or PDA, for further accessibility. Also, a pre-qualification phase may be provided on the website, in which a visitor 14 would be required to successfully complete a first challenge in order to qualify for a visit of the exhibit.

Referring now to FIG. 8 and still according to an alternative illustrative embodiment of the present invention, the system 10 may enable adaptation of a movie or videogame adventure/quest in a three-dimensional (3D) environment. In this case, a plurality of locations as in 12, illustratively a minimum of five (5) locations as in 12, are provided, which can be a combination of public buildings, outdoor sites and closed rooms controlled by the system 10. The closed rooms are illustratively used when it is desirable to integrate technology, such as wireless Internet access or elaborate audio visual/information technology (AV/IT) setups. For instance, controlled environments are preferred when it is desired to recreate a scene (e.g. scene of a movie) and partially control the interaction of the visitors as in 14 with specific characters, thus achieving a more elaborate scenography. When a movie is adapted in 3D, the locations of the movie (e.g. casino, warehouse) can illustratively be completely recreated in the physical layout of the locations as in 12 or be located in a city having locations as in 12 closely resembling those of the movie. In the case of a videogame adapted in 3D, different environments can be provided where a visitor 14 is prompted to complete tasks in order to gather points and/or keys to enter the next location 122.

Still referring to FIG. 8, the visitors as in 14 are again directed to an introduction zone 32 where they are prompted to register by providing information that will constitute their unique profile, as discussed herein above. Illustratively, the visitors as in 14 are also assigned a mobile communications device 40 (e.g. mobile phone, PDA), on which their unique profile information is preferably stored. Illustratively, the mobile device 40 is in communication (e.g. wireless) with the central computer 18 via a mobile network (not shown). The visitor 14 is further introduced to the technology of the mobile device 40 and to the plot of the game or movie (e.g. via the mobile device 40 or by an attendant (not shown)) in order to ease the experience. In such an embodiment, it may be desirable to implement a challenge component so as to enhance the experience by making it more interactive. For example, the plot could be that an invaluable historical object has been stolen from its display in an exhibition hall and the thief left in its place a coded message. The quest through the venue will illustratively give visitors as in 14 clues to decipher the coded message, which, once decoded, leads to the secret hiding place of the stolen object. Illustratively, each visitor 14 is illustratively assigned a character and, as such, visitors as in 14 preferably have to play the character's part in the unfolding of the movie or game adventure. The challenge is thus preferably a group effort and in order to achieve successful accomplishment, it is desirable for all visitors as in 14 to complete their individual challenges.

Still referring to FIG. 8, similarly to the previous embodiment, the central computer 18, after introducing the visitor 14 to the experience, directs the visitor 14 to a first location ¹²1. For this purpose, the mobile device 40 is equipped with an interface, such as a display (not shown), speaker, and the like, for rendering any information provided to the visitor 14. The visitor 14 is for example directed to a public building (not shown) where the sought object was displayed and stolen. The mobile device 40 is illustratively in communication with the central computer 18 throughout the experience via the mobile device 40. For instance, the mobile device 40 connects with the central computer 18 in order to retrieve clues or directions to direct the visitors as in 14 to the various locations as in 12. Subsequently and on a regular basis during the game, the central computer 18 illustratively retrieves challenges, and/or time limits for completing the latter from the content database 20 and sends this information to the mobile device 40 in real-time.

Still referring to FIG. 8, the visitor 14 is then prompted via the portable device 40 to perform the tasks/challenges and report back to the central computer 18 using the user interface on the mobile device 40. Every correct answer illustratively earns points, which may be exchanged for additional clues that direct the visitor 14 along his/her itinerary. For example, as a first task, the visitor 14 may be prompted by the mobile device 40 to take for future reference a picture of the coded message left in its place of the stolen object, examine the space around the first location 12₁, and listen to and share information presented by a policeman or security guard. This information could include a recap of events, such as the fact that, according to witnesses, a suspicious individual was first spotted exiting the building with a voluminous bag and then again a few blocks away from the first location 12₁, entering a park.

Still referring to FIG. 8, upon completion of the first task, the central system 18 illustratively directs the visitor 14 to a second location 12₂ (e.g. a nearby park) to retrieve another clue. In the park, the visitor 14 notices a statue with a plaque, on which some of the text included in the coded message is inscribed. Upon being prompted by the mobile device 40 for this first clue, the visitor 14 sends a response to the central computer 18 via a suitable communication means such as text messaging. If the answer is correct, the central computer 18 sends a response to the mobile device 40 in the form of a map and a further question to be answered. Upon following the directions on the map, the visitor 14 is led to a new location 12₃ where he/she gets another clue, directing him/her to the next location 12₄ and so on until the last location 12₁₀ is reached. Examples of clues include riddles, maps, visual icons, and the like. Examples of challenges include intellectual challenges, such as solving a mathematical problem, and physical challenges, such as racing. The answers to each challenge are illustratively sent by the visitor 14 to the central computer 18 using a user interface (not shown), such as a keyboard, microphone, or the like, provided on the mobile device 40. Illustratively, the experience is designed such that the last location 12₁₀ is the culmination point where the player 14 links together all the clues he/she gathered along the itinerary. For example, the last location 12₁₀ could be the hiding place of the stolen object, which may be recuperated by the visitor 14 upon solving an ultimate challenge. Preferably, the last challenge is held in a controlled environment where video projections and special effects can be staged.

Still referring to FIG. 8 and similarly to the embodiment described herein above, the process of providing the visitors as in 14 with clues and directing the visitors as in 14 between the plurality of locations as in 12 is repeated until the visitor's itinerary is fully completed. Based on the visitor's profile, the central computer 18 randomly selects the locations as in 12 and challenges, if any, which constitute the itinerary and experience of the visitors as in 14. Again, given the plurality of different locations as 12, levels of play, and challenges available, this random selection allows for a diversification of itineraries and experiences. A visitor 14 wishing to repeat the experience is therefore ensured to have a different itinerary and different challenges (as illustrated in FIG. 7A and FIG. 7B).

Although the present invention has been described hereinabove by way of specific embodiments thereof, it can be modified, without departing from the spirit and nature of the subject invention as defined in the appended claims.

What is claimed is:

1. A method for providing an interactive experience to a visitor of an entertainment venue comprising a plurality of locations, the method comprising the acts of:
a. providing information uniquely identifying the visitor;
b. assigning the visitor a portable identification device having stored thereon said information;
c. randomly directing the visitor to a first one of the plurality of locations;
d. retrieving at said first one of the plurality of locations said information from said identification device, thereby identifying the visitor;
e. presenting the visitor with content customized according to said retrieved information; and
f. repeating acts c, d, and e for remaining ones of the plurality of locations.

2. The method of claim 1, wherein said providing information uniquely identifying the visitor comprises the visitor submitting during a registration phase identification information and a preference profile.

3. The method of claim 2, further comprising storing in a profile database said information uniquely identifying the visitor and statistics about the experience of the visitor at the entertainment venue.

4. The method of claim 1, further comprising storing in a content database content information associated with items on display at the plurality of locations, classifying said content information using a plurality of indexes and assigning each one of said plurality of indexes to a corresponding one of the plurality of locations.

5. The method of claim 4, wherein said randomly directing the visitor to a first one of the plurality of locations comprises randomly retrieving a first one of said plurality of indexes and directing the visitor to a selected one of the plurality of locations corresponding to said retrieved index.

6. The method of claim 1, wherein said retrieving at said first one of the plurality of locations said information comprises receiving a signal emitted by said identification device, said signal carrying said information uniquely identifying the visitor, and interpreting said signal for identifying the visitor and allowing access to said first one of the plurality of locations.

7. The method of claim 4, wherein said presenting the visitor with said customized content comprises retrieving from said content database content information matching said retrieved information and displaying said retrieved content on an electronic content delivery platform provided at said first one of the plurality of locations.

8. The method of claim 1, wherein said customized content comprises a challenge component.

9. The method of claim 8, wherein act f is performed upon successful completion of said challenge component.

10. The method of claim 8, wherein act f is performed upon expiry of a predetermined time limit for completing said challenge component.

11. The method of claim 1, wherein providing the interactive experience comprises adapting a selected one of a motion picture or a game in a three-dimensional environment.

12. A system for providing an interactive experience to a visitor of an entertainment venue comprising a plurality of locations, the system comprising:
a portable identification device assigned to the visitor and having stored thereon information uniquely identifying the visitor; and
a computer system in communication with said identification device and said plurality of locations,
wherein said computer system
a. randomly directs the visitor to a first one of the plurality of locations,
b. retrieves at said first one of the plurality of locations said information from said identification device, thereby identifying the visitor,
c. presents the visitor with content customized according to said retrieved information, and
d. repeats acts a, b, and c for remaining ones of the plurality of locations.

13. The system of claim 12, wherein said information uniquely identifying the visitor comprises identification information comprising a name, demographic information, and contact information of the visitor, and a preference profile comprising a language preference, an ability level, and an interest profile of the visitor.

14. The system of claim 12, further comprising a profile database for storing said information uniquely identifying the visitor and statistics about the experience of the visitor at the entertainment venue, said profile database in communication with said computer system.

15. The system of claim 12, wherein said portable identification device is adapted to emit a signal carrying said information uniquely identifying the visitor and is selected from the group consisting of an RFID bracelet, a smart card, a magnetic stripe card, and a mobile communications device.

16. The system of claim 15, wherein said first one of the plurality of locations comprises a reader communicating with an antenna adapted to receive said signal, said reader adapted to interpret said received signal for identifying the visitor and allowing access to said first one of the plurality of locations.

17. The system of claim 12, further comprising a content database in communication with said computer system and comprising content information associated with items on display at the plurality of locations, said content information being indexed within said content database, wherein said customized content presented to the visitor is retrieved from said content database and comprises content information matching said retrieved information.

18. The system of claim 16, further comprising at said first one of the plurality of locations an electronic content delivery platform for presenting said customized content to the visitor thereon.

19. The system of claim 18, further comprising at said first one of the plurality of locations a control module in communication with said computer system, said reader, and said electronic content delivery platform for controlling access to the plurality of locations and controlling the presentation of said customized content on said electronic delivery platform according to said retrieved information.

20. The system of claim 18, wherein said electronic content delivery platform comprises a main screen and a plurality of individual monitors.

21. The system of claim 20, wherein the visitor is directed to a selected one of said plurality of individual monitors, and further wherein the visitor is identified through said identification device at said selected one of said plurality of individual monitors for being presented said customized content thereon.
